(19) United States
(12) Patent Application Publication
(10) Pub. No.: US 2010/0216903 A1
(43) Pub. Date: Aug. 26, 2010

(54) FOAM-FORMING SYSTEM WITH REDUCED VAPOR PRESSURE

(75) Inventor: Michael A. Dobransky, Pittsburgh, PA (US)

Correspondence Address: BAYER MATERIAL SCIENCE LLC, 100 BAYER ROAD, PITTSBURGH, PA, 15205, US

(73) Assignee: Bayer MaterialScience LLC, Pittsburgh, PA (US)

(21) Appl. No.: 12/389,510

(22) Filed: Feb. 20, 2009

(51) Int. Cl. C08J 9/00; C09K 3/00

(52) U.S. Cl. 521/117; 252/182.18

(57) ABSTRACT

An isocyanate-reactive composition containing a blowing agent that includes HFC 134a and water characterized by a vapor pressure which is lower than that of comparable compositions which do not include the stabilizing composition of the present invention. The stabilizing composition of the present invention includes an ethoxylated nonylphenol and propylene carbonate. This stabilizing composition is included in the isocyanate-reactive composition in an amount sufficient to promote the solubility of the blowing agent. The isocyanate-reactive composition may be stored at ambient conditions rather than under pressure and may be hand mixed with an isocyanate to produce a foam. The isocyanate-reactive composition containing blowing agent of the present invention may be used to produce foams having good physical properties after storage at ambient temperature and pressure for periods as long as 3 months.

### BACKGROUND OF THE INVENTION

The present invention relates to a foam-forming system in which 1,1,1,2-tetrafluoroethane (“HFC-134a”) and water are used as the blowing agent which system is characterized by reduced vapor pressure and to a process for the production of foams from this system.

Formulations and processes for the production of foams, particularly rigid polyurethane foams, are known. Foam producers have replaced the ozone depleting CFC and HCFC blowing agents with more environmentally desirable blowing agents. Among the blowing agents being used are the hydrofluorocarbons (“HFCs”). Many of these alternative blowing agents have sufficiently low boiling points that they exist in the gaseous form at normal ambient temperature and pressure (20-30° C. and no greater than 15 psia). Consequently, it has not been possible to incorporate these blowing agents into foam-forming formulations until very shortly before use without maintaining the formulation containing the blowing agent under conditions of reduced temperature and/or elevated pressures that ensure the blowing agent stays dissolved in the liquid state. See, e.g., U.S. Pat. Nos. 3,541,023; 5,451,614; and 5,470,891.

Blowing agent is generally included in the “B-side” of the foam-forming mixture in an amount of from about 3 to about 25% by weight. In use, the gaseous blowing agent is typically added to the day tanks of the foam machine prior to foaming. This requires the foam producer to handle the gaseous blowing agent and ensure that it is blended correctly. The gaseous blowing agent may also be added as a separate, third stream at the mix head, along with the isocyanate and isocyanate-reactive component.

The gaseous blowing agent may also be added to the “B-side” (i.e., the isocyanate-reactive component) prior to foaming during blending of that isocyanate-reactive component However, the need to store a formulation into which blowing agent has been incorporated under controlled temperature and pressure conditions, increases the expense of handling and storing such formulations. It would therefore be advantageous to develop a foam-forming formulation into which a blowing agent such as HFC 134a that is a gas at normal ambient conditions could be incorporated and which would exhibit a substantially lower vapor pressure.

U.S. Pat. No. 4,972,003 teaches that use of an isocyanate-reactive compound having an equivalent weight of greater than 140 promotes the solubility of HCFC and HFC blowing agents having boiling points below 272° K. This patent does not, however, teach that the disclosed mixtures of isocyanate-reactive compound and blowing agent are sufficiently stable that they do not exert a considerable vapor pressure. Nor does this disclosure suggest that foams can be produced from the disclosed “stable” composition by hand mixing techniques.

U.S. Pat. No. 5,578,651 discloses a process for the production of rigid polyurethane foams in which a polyisocyanate is reacted with an isocyanate-reactive compound having a molecular weight of from 92 to 10,000 and at least two hydrogen atoms in the presence of an HFC blowing agent, a solubilizer, and other optional additives. 1,1,1,4,4,4-hexafluorobutane (“HFC 356”) is taught to be the preferred blowing agent and is the only blowing agent used in the examples given in this disclosure. Solubilizers which are taught to be useful are represented by specified formulae. Preferred solubilizers include: propylene carbonate, triethyl phosphate, tributyl phosphate and dioctyl phthalate. This patent teaches that use of one of the required solubilizers increases the solubility of partially fluorinated hydrocarbons so that a one-phase polyol component is obtained. This patent does not, however, teach that use of any of the solubilizers disclosed therein will render the isocyanate-reactive component sufficiently stable that it will not exert a considerable vapor pressure. Nor does this patent teach that foams can be produced by hand mixing techniques from the isocyanate-reactive mixture disclosed therein.

U.S. Pat. No. 6,262,136 discloses a storage stable foam-forming system in which a phenol or an alkylphenol having at least one phenolic hydroxyl group is included in an isocyanate-reactive composition containing a polyol and an organic blowing agent. The blowing agent employed must include at least one hydrogen and at least one fluorine and must be a gas at ambient pressure. Among the phenols and alkylphenols taught to be suitable for use in the compositions disclosed in this patent are the ethoxylated phenols, particularly ethoxylated nonylphenols, resorcinol, catechol, hydroquinone, 1,2,3-trihydroxybenzene, 1,3,5-trihydroxybenzene and 1,2,4-trihydroxybenzene. This patent teaches that the disclosed system is storage stable for up to three months but does not teach that these systems are sufficiently stable that they will not exert a considerable vapor pressure. Nor does this patent teach that foams can be produced by hand mixing techniques from the isocyanate-reactive compositions disclosed therein.

It has now been found that unexpectedly high levels of the gaseous blowing agent 1,1,1,2-tetrafluoroethane (HFC-134a) and water may be incorporated into the B-side of a foam-forming composition at atmospheric pressure if a particular combination of solubility-enhancing additives is included in the B-side. The incorporated blowing agent does not separate from the other components present in the B-side and exerts significantly less pressure than the pressure exerted by HFC-134a in isocyanate-reactive components which do not include the additives required for the present invention.

### SUMMARY OF THE INVENTION

It is an object of the present invention to provide a storage-stable isocyanate-reactive composition that includes a blowing agent composition having significant amounts of both HFC-134a and water.

It is another object of the present invention to provide a storage-stable polyol/blowing agent composition that may be transported and stored at ambient temperature at reduced pressure.

It is also an object of the present invention to provide a storage-stable polyol/blowing agent composition having significant amounts of HFC-134a and water which is sufficiently stable that the vapor pressure exerted by the HFC-134a is less than compositions which do not include the additives required in the present invention.

It is an additional object of the present invention to provide a storage-stable polyol/blowing agent composition which can be hand mixed to produce a rigid polyurethane foam.

It is a further object of the present invention to provide a process for the production of rigid foams, especially rigid polyurethane foams, having good physical properties from an isocyanate-reactive composition containing a blowing agent composition that includes HFC 134a and an amount of water.

These and other objects which will be apparent to those skilled in the art are accomplished by combining (1) an isocyanate-reactive material such as a polyether polyol or a polyester polyol; (2) HFC-134a; (3) water; (4) a nonylphenol ethoxylate; and (5) propylene carbonate. The isocyanate-reactive composition of the present invention generates less vapor pressure than a corresponding blend of the same isocyanate-reactive material, HFC-134a and water which does not include nonylphenol ethoxylate and propylene carbonate, and may be stored for periods up to as long as 3 months before it is reacted with an isocyanate to produce a foam such as a rigid polyurethane foam.

### BRIEF DESCRIPTION OF THE FIGURE

FIG. 1 graphically illustrates the vapor pressure versus temperature curve for the blends produced in Examples 1 and 2.

### DETAILED DESCRIPTION OF THE INVENTION

The present invention relates to isocyanate-reactive compositions which include a blowing agent composition in which significant amounts of HFC-134a and water are present and to the use of such isocyanate-reactive compositions for the production of foams.

Any of the isocyanate-reactive materials having a hydroxyl or amino functionality of from about 1 to about 8, preferably from about 2 to about 6.5 and an hydroxyl or amine number of from about 25 to about 1850 mg KOH/g, preferably from about 250 to about 600 mg KOH/g known to those skilled in the art may be used in the practice of the present invention.

Suitable isocyanate-reactive materials include organic materials which generally contain two or more isocyanate reactive hydrogen atoms. Examples of suitable isocyanate-reactive materials include polyols and polyamines. Polyols are particularly preferred. Examples of appropriate polyols include polyester polyols, polyether polyols, polyhydroxy polycarbonates, polyhydroxy polyacetals, polyhydroxy polyacrylates, polyhydroxy polyester amides and polyhydroxy polythioethers. Polyester polyols, polyether polyols and polyhydroxy polycarbonates are preferred.

Suitable polyester polyols include the reaction products of polyhydric alcohols (preferably dihydric alcohols to which trihydric alcohols may be added) and polybasic (preferably dibasic) carboxylic acids. In addition to the polycarboxylic acids, corresponding carboxylic acid anhydrides or polycarboxylic acid esters of lower alcohols or mixtures thereof may also be used to prepare the polyester polyols useful in the practice of the present invention. The polycarboxylic acids may be aliphatic, cycloaliphatic, aromatic and/or heterocyclic and they may be substituted (e.g. by halogen atoms) and/or unsaturated. Examples of suitable polycarboxylic acids include: succinic acid; adipic acid; suberic acid; azelaic acid; sebacic acid; phthalic acid; isophthalic acid; trimellitic acid; phthalic acid anhydride; tetrahydrophthalic acid anhydride; hexahydrophthalic acid anhydride; tetrachlorophthalic acid anhydride, endomethylene tetrahydrophthalic acid anhydride; glutaric acid anhydride; maleic acid; maleic acid anhydride; fumaric acid; dimeric and trimeric fatty acids such as oleic acid, which may be mixed with monomeric fatty acids; dimethyl terephthalates and bis-glycol terephthalate. Suitable polyhydric alcohols include: ethylene glycol; 1,2- and 1,3-propylene glycol; 1,3- and 1,4-butylene glycol; 1,6-hexanediol; 1,8-octanediol; neopentyl glycol; cyclohexanedimethanol; (1,4-bis(hydroxymethyl)cyclohexane); 2-methyl-1,3-propanediol; 2,2,4-trimethyl-1,3-pentanediol; triethylene glycol; tetraethylene glycol; polyethylene glycol; dipropylene glycol; polypropylene glycol; dibutylene glycol and polybutylene glycol, glycerine and trimethylol-propane. The polyesters may also contain a portion of carboxyl end groups. Polyesters of lactones, e.g., caprolactone or hydroxyl carboxylic acids such as ω-hydroxycaproic acid, may also be used.

Suitable polycarbonates containing hydroxyl groups include those obtained by reacting diols with phosgene, a diarlycarbonate (e.g., diphenyl carbonate) or cyclic carbonates (e.g., ethylene or propylene carbonate). Examples of suitable diols include: 1,3-propanediol; 1,4-butanediol; 1,6-hexanediol; diethylene glycol; triethylene glycol; and tetraethylene glycol. Polyester carbonates obtained by reacting polyesters or polylactones (such as those described above) with phosgene, diaryl carbonates or cyclic carbonates may also be used in the practice of the present invention.

Polyether polyols which are suitable for practicing the present invention include those obtained in known manner by reacting one or more starting compounds which contain reactive hydrogen atoms with alkylene oxides such as ethylene oxide, propylene oxide, butylene oxide, styrene oxide, tetrahydrofuran, epichlorohydrin or mixtures of these alkylene oxides. Polyethers which do not contain more than about 10% by weight of ethylene oxide units are preferred. Polyethers obtained without the addition of ethylene oxide are most preferred. Suitable starting compounds containing reactive hydrogen atoms from which such polyether polyols may be produced include polyhydric alcohols (described above as being suitable for preparing polyester polyols); water; methanol; ethanol; 1,2,6-hexane triol; 1,2,4-butane triol; trimethylol ethane; pentaerythritol; mannitol; sorbitol; methyl glycoside; sucrose; phenol; isononyl phenol; resorcinol; hydroquinone; and 1,1,1- or 1,1,2-tris-(hydroxyl phenyl)-ethane.

Polyethers modified by vinyl polymers are also suitable for producing the compositions of the present invention. Such modified polyethers may be obtained, for example, by polymerizing styrene and acrylonitrile in the presence of a polyether (U.S. Pat. Nos. 3,383,351; 3,304,273; 3,523,095; 3,110,695 and German Patent No.1,152,536).

The polythioethers useful in the practice of the present invention include the condensation products obtained from thiodiglycol on its own and/or with other glycols, dicarboxylic acids, formaldehyde, amino-carboxylic acids or amino alcohols. These condensation products may be polythio-mixed ethers, polythioether esters or polythioether ester amides, depending on the co-components.

Amine-terminated polyethers useful in preparing the compositions of the present invention may be prepared by reacting a primary amine with a polyether containing terminal leaving groups such as halides, or mesylates as disclosed in U.S. Pat. Nos. 3,666,726; 3,691,112; 5,066,824; and 5,693,864. Such amines are sold under the name Jeffamine.

Low molecular weight isocyanate reactive materials may optionally be included in the isocyanate-reactive compositions of the present invention. Appropriate low molecular weight, isocyanate-reactive compounds useful in the practice of the present invention will generally have from 1 to 3 hydroxyl groups, preferably 2 hydroxyl groups, and have an average molecular weight of from about 60 to about 200, preferably from about 100 to about 150. Useful low molecular weight isocyanate-reactive materials include the polyhydric alcohols which have previously been described as suitable for the preparation of the polyester polyols and polyether polyols. Dihydric alcohols are preferred. The weight ratio of the low molecular weight to the high molecular weight material containing two or more hydroxyl groups is generally from about 0.001 to about 2, preferably from about 0.01 to about 0.40.

In addition to the above-mentioned isocyanate-reactive compounds, monofunctional and even small amounts of trifunctional and higher functionality compounds of the type generally known in polyurethane chemistry may be used to produce the compositions of the present invention. For example, trimethylolpropane may be used in cases in which slight branching is desired.

Catalysts which may be used to aid the foam-forming reaction are also often included in the isocyanate-reactive compositions of the present invention. Examples of catalysts useful for promoting urethane reactions include di-n-butyl tin dichloride, di-n-butyl tin diacetate, di-n-butyl tin dilaurate, triethylenediamine, bismuth nitrate, 1,4-diaza-bicyclo-[2,2,2]octane, dimethylethanolamine, dimethylcyclohexylamine and pentamethyldiethylenetriamine.

The blowing agent included in the isocyanate-reactive composition of the present invention is a combination of 1,1,1,2-tetrafluoroethane (HFC-134a) and water. 1,1,1,2-tetrafluoroethane (HFC-134a) has a boiling point of −26° C. In the blowing agent combination of HFC-134a and water, HFC-134a may be present in an amount of from 50 to 90 wt. %, based on total weight of blowing agent, preferably from 75 to 90 wt. %, most preferably from 75 to 85 wt. %. The water is generally present in an amount of from about 1.0 to about 4.0 wt. %, based on total weight of the isocyanate reactive blend, preferably, from about 1.0 to about 3.5 wt. %, most preferably, from about 1.5 to about 3.0 wt. %.

Other, known low-boiling blowing agents may be used in addition to the HFC-134a and water required in the present invention. However, such additional blowing agents should not be used in an amount that would adversely affect the vapor pressure of the isocyanate-reactive composition, i.e., generally not in an amount greater than 20 wt. %, based on total weight of the blowing agent composition.

The ethyoxylated nonylphenol used to promote the solubility of HFC-134a in the isocyanate-reactive material in accordance with the present invention is a phenol in which the aromatic ring has been ethoxylated to the extent that at least 9 ethylene oxide groups are present on the ring. Suitable ethoxylated nonylphenols which are commercially available include those which are sold under the names Igepal CO-630 (Chem Service, Inc.), Tergitol NP-9 (Union Carbide) and Surfonic N-95 (Texaco). The ethoxylated nonlyphenol is generally included in the isocyanate-reactive component in an amount of from 5 to 20 wt. %, based on total weight of isocyanate-reactive component, preferably, from 5 to 15 wt. %, most preferably, from 7 to 15 wt. %.

The other material used to promote the solubility of HFC-134a in the isocyanate-reactive material in accordance with the present invention is propylene carbonate. The propylene carbonate is generally included in the isocyanate-reactive component in an amount of from 5 to 20 wt. %, based on total weight of isocyanate-reactive component, preferably, from 5 to 15 wt. %, most preferably, from 6 to 12 wt. %.

The total amount of solubility promoting agent (i.e., weight of ethoxylated nonylphenol plus weight of propylene carbonate) included in the isocyanate-reactive compositions of the present invention is generally from about 5 to about 30% by weight, preferably from about 10 to about 20% by weight, based on the total weight of the isocyanate-reactive composition.

The ethoxylated nonylphenol and propylene carbonate are used in amounts such that the weight ratio of ethoxylated nonylphenol to propylene carbonate is from 20:80 to 80:20, preferably, from 25:75 to 75:25, most preferably, from 30:70 to 70:30.

The blowing agent composition (i.e., HFC-134a, water and any additional blowing agent) is generally included in the isocyanate-reactive compositions of the present invention in an amount of from about 2 to about 20% by weight, based on the total weight of isocyanate-reactive composition, preferably from about 5 to about 15% by weight.

Optional materials which may be included in the isocyanate-reactive compositions of the present invention such as catalysts, surfactants, etc. are generally included in the isocyanate-reactive component in amounts which total up to 7% by weight, preferably from about 0.1 to about 5% by weight, based on the total weight of the isocyanate-reactive composition exclusive of any flame retardant.

Any of the known isocyanates may be used to produce polyurethane foams from the isocyanate-reactive compositions of the present invention. Specific examples of suitable isocyanates include: toluene diisocyanate (“TDI”), diphenylmethane diisocyanate (“MDI”), and polyphenyl polymethylene polyisocyanate (“Polymeric MDI”) and isocyanate-terminated prepolymers of these isocyanates.

The isocyanate and isocyanate-reactive components may be reacted to form polyurethane foam by any of the known methods under the usual processing conditions. Examples of suitable methods include: hand mixing with an air driven or electric motor mixer and a conventional pour in place method in which a liquid mixture is dispensed.

The isocyanate and isocyanate-reactive composition are generally reacted in amounts such that the equivalent ratio of isocyanate to isocyanate-reactive groups is from about 0.9 to about 2.5, preferably from about 1.0 to about 1.5.

The storage stable isocyanate-reactive compositions of the present invention are stable at ambient temperature for periods of up to three months, generally at least two months.

Having thus described my invention, the following Examples are given as being illustrative thereof. All parts and percentages given in these Examples are parts by weight and percentages by weight, unless otherwise indicated.

### EXAMPLES

The materials used in the Examples which follow were:
POLYOL A: an aromatic amine-initiated polyether polyol having an OH number of from 385-405 mg KOH/g and a functionality of about 4 which is available from Bayer MaterialScience LLC under the designation Multranol 8114.
POLYOL B: A sucrose-based polyether polyol having a functionality of about 5.8 and an OH number of from 370 to 390 mg KOH/g which is commercially available under the name Multranol 4030 from Bayer MaterialScience LLC.
POLYOL C: A Glycerine initiated polyether polyol having a functionality of about 3.0 and an OH number of about 240 mg KOH/g which is available from Bayer MaterialScience LLC under the designation Arcol LHT-240.
POLYOL D: A sucrose-based polyether polyol having a functionality of about 5.2 and an OH number of about 470 mg KOH/g which is commercially available under the name Multranol 4034 from Bayer MaterialScience LLC.
POLYOL E: A sucrose-based polyether polyol having a functionality of about 6.2 and an OH number of from about 330 to about 350 mg KOH/g which is commercially available under the name Multranol 9171 from Bayer MaterialScience LLC.
POLYOL F: An amine-initiated polyether polyol having an OH number of 350 and a functionality of 3 which is commercially available under the name Multranol 9170 from Bayer MaterialScience LLC.
POLYOL G: A propoxylated triol based on glycerine having an OH number of approximately 470 which is commercially available under the name Multranol 9158 from Bayer MaterialScience LLC.
PC: Propylene Carbonate
SOL A: The ethoxylated nonylphenol which is commercially available from Texaco under the name Surfonic N-95.
PC 8: Dimethylcyclohexylamine, commercially available from Air Products under the name Polycat 8.
HFC 134a: 1,1,1,2-tetrafluoroethane.
B8484: A silicon surfactant which is commercially available from Evonik Goldschmidt under the name Tegostab B-8484.
B8465: A polyether modified polysiloxane surfactant which is commercially available from Evonik Goldschmidt under the name Tegostab B-8465.
PV: A catalyst for polyurethane-forming reactions which is commercially available from Rhein Chemie under the name Desmorapid PV.
DB: A catalyst for polyurethane-forming reactions which is commercially available from Rhein Chemie under the name Desmorapid DB.
PCF: Tris(p-chloroisopropyl)phosphate, a flame retardant which is commercially available from Great Lakes Chemical under the name Fyrol PCF.
NCO: The polymeric diphenylmethane diisocyanate having an NCO content of 31.5% by weight which is commercially available under the name Mondur MR from Bayer MaterialScience LLC.

### EXAMPLES

### Examples 1-2

POLYOL A, PC and SOL A, each used in the amount listed in Table 1, were blended and 400 g of this blend were placed into a 600 ml Parr pressure vessel equipped with an agitator and a pressure gauge. The sealed vessel was then weighed and purged with HFC-134a by repeatedly pressurizing to 50 psig and venting to ensure that all of the air had been removed from the head space. 49.4 g of HFC-134a were then added to prepare a blend containing 1 1% HFC-134a (minus the amount of blowing agent in the head space).

TABLE 1

Example

| | 1* | 2 |
|---|---|---|
| POLYOL A | 400 | 320 |
| (g) | | |
| PC (g) | — | 40 |
| SOL A (g) | — | 40 |
| HFC-134a | 49.4 | 49.4 |

*Comparative Example

The blend containing HFC-134a was then cooled to below 10° C. and allowed to equilibrate while agitating. This blend was then slowly warmed and the vapor pressure and temperature were periodically recorded.

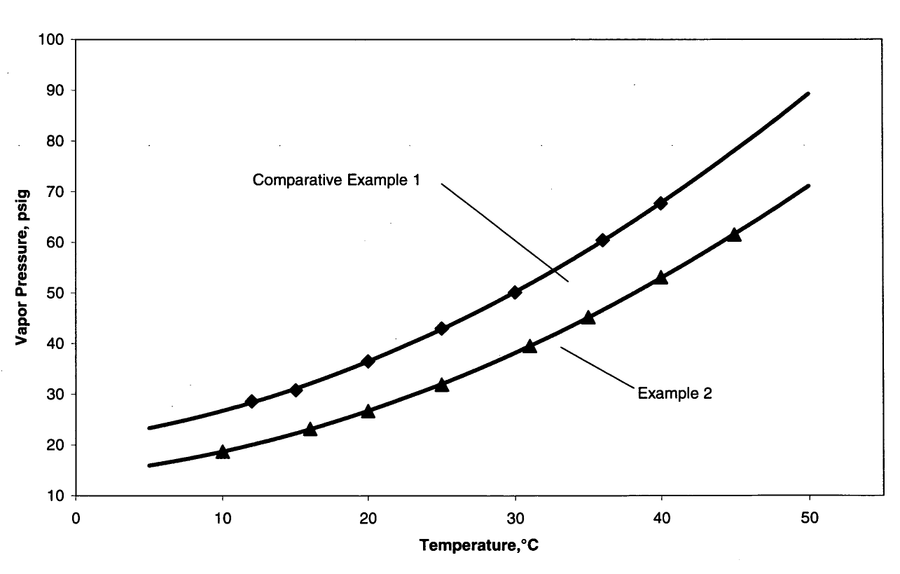

The pressure versus temperature curves for these blends are shown in FIG. 1. This graph clearly shows that the combination of propylene carbonate and ethoxylated nonylphenol reduces the vapor pressure of the HFC-134a in the blend.

### Examples 3 - 8

HFC-134a was bubbled into a vessel containing a blend composed of the materials listed in Table 2 in the amounts listed in Table 2 at ambient temperature and a pressure of approximately 730 mm Hg. The amount of HFC-134a absorbed is reported in Table 2. 100 parts of the HFC-134a containing formulations described in Table 2 were hand mixed with the given amount of NCO for 10 seconds before pouring into a box to form a polyurethane foam. The foam properties are reported in Table 2 for those blends which could be hand mixed. The desired amount of HFC 134a could not be added in comparative Example 3.

TABLE 2

| | Example | | | | | |
|---|---|---|---|---|---|---|
| | 3* | 4 | 5 | 6 | 7 | 8 |
| Polyol B (pbw) | 30.61 | 23.32 | 21.00 | 20.00 | — | 31.06 |
| Polyol C (pbw) | 29.66 | 22.60 | 25.00 | 23.00 | — | — |
| Polyol D (pbw) | 23.73 | 18.08 | 20.00 | 18.00 | — | — |
| Polyol E (pbw) | — | — | — | — | 47.44 | — |
| Polyol F (pbw) | — | — | — | — | 20.32 | — |
| Polyol G (pbw) | — | — | — | — | — | 15.52 |
| Polyol A (pbw) | — | — | — | — | — | 15.52 |
| SOL A (pbw) | — | 10.00 | 10.00 | 10.00 | 10.90 | 10.00 |
| PC (pbw) | — | 10.00 | 8.00 | 8.00 | 5.00 | 11.00 |
| B-8484 (pbw) | 2.20 | 2.20 | — | — | — | — |
| B-8465 (pbw) | — | — | 2.20 | 2.20 | 1.73 | 2.50 |
| PC-8 (pbw) | 0.80 | 0.80 | 0.80 | 0.80 | — | 0.80 |
| PV (pbw) | — | — | — | — | 0.27 | — |
| DB (pbw) | — | — | — | — | 1.04 | — |
| PCF (pbw) | — | — | — | 5.00 | — | — |
| Water (pbw) | 2.00 | 2.00 | 2.00 | 2.00 | 2.30 | 2.60 |
| HFC 134a (pbw) | 11.00* | 11.00 | 11.00 | 11.00 | 11.00 | 11.00 |
| | 100.00 | 100.00 | 100.00 | 100.00 | 100.00 | 100.00 |
| NCO (pbw) | *Could not | 102.0 | 102.0 | 100.0 | 106.0 | 111.0 |
| Resin Temperature, | add the | 10 | 10 | 10 | 10 | 10 |
| ° C. | desired | | | | | |
| Iso Temperature, | amount of | 20 | 20 | 20 | 20 | 20 |
| ° C. | HFC | | | | | |
| Mix Time, seconds | 134a. | 10 | 10 | 10 | 10 | 10 |
| Gel Time, seconds | | 182 | 186 | 175 | 155 | 118 |
| Tack Free Time, seconds | | n/a | 645 | n/a | 372 | 300 |
| Free Rise Density, lb/ft³ | | 2.00 | 2.18 | 2.09 | 1.91 | 1.62 |

*Comparative Example
pbw = parts by weight

### Example 9

In this example, the formulation from Example 5 was foamed on a Hennecke HK-100 high pressure foam machine equipped with a Hennecke MQ-12 mix head. The polyol and isocyanate temperatures were both controlled at 70° F. and the total liquid throughput was adjusted to 57.5 lb/minute. The pre-foam mixture was injected into a vertical panel mold measuring 5 cm thick×20 cm wide×200 cm high and allowed to react. The key foam properties obtained from these panels are presented in Table 3.

TABLE 3

| | Example |
|---|---|
| | 9 |
| Minimum Fill Density, lb/ft³ | 2.24 |
| Packed density, lb/ft³ | 2.34 |
| Average Core Density, lb/ft³ | 2.12 |
| Parallel Compressive Strength, lb/in² | 30.83 |
| Perpendicular Compressive Strength, lb/in² | 20.57 |
| Closed Cells, % | 86.4 |
| k-Factor at 75° F., BTU-in/hr-ft²-° F. | 0.162 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. An isocyanate-reactive composition which includes a blowing agent and is storage stable at ambient temperature comprising.
a) a polyol,
b) a blowing agent comprising HFC 134a and water, and
c) a stabilizing composition comprising
(1) ethoxylated nonylphenol and
(2) propylene carbonate
in which the stabilizing composition is used in an amount sufficient to promote the solubility of blowing agent b) in polyol a).

2. The composition of claim 1 in which polyol a) is a polyether polyol or a mixture of polyether polyols.

3. The composition of claim 1 in which the stabilizing composition c) is present in an amount of from about 5 to about 30 parts by weight, based on the isocyanate-reactive composition's total weight.

4. The composition of claim 1 in which the ethoxylated nonylphenol is present in an amount of from about 5 to about 20 parts by weight, based on the isocyanate-reactive composition's total weight.

5. The composition of claim 1 in which the blowing agent comprises from 50 to 90% by weight, based on total weight of blowing agent, HFC-134a.

6. The composition of claim 5 in which the water is present in an amount of from 1 to about 4% by weight, based on the isocyanate-reactive composition's total weight.

7. The composition of claim 1 in which the water is present in an amount of from 1 to about 4% by weight, based on the isocyanate-reactive composition's total weight.

8. A process for the production of a rigid foam comprising reacting the isocyanate-reactive composition of claim 1 with a polyisocyanate.

9. The process of claim 8 in which the polyisocyanate is polyphenyl polymethylene polyisocyanate.

10. A process for the production of a rigid foam comprising reacting the isocyanate-reactive composition of claim 3 with a polyisocyanate.
